(19) United States
(12) Patent Application Publication
(10) Pub. No.: US 2014/0158536 A1
(43) Pub. Date: Jun. 12, 2014

(54) Sensor Apparatus

(71) Applicant: United Science LLC, Center City, MN (US)

(72) Inventors: Jonathan Thompson, Center City, MN (US); Chunze Lai, Kendall Park, NJ (US); Li Chen, Dallas, TX (US)

(73) Assignee: United Science LLC, Center City, MN (US)

(21) Appl. No.: 14/079,455

(22) Filed: Nov. 13, 2013

Related U.S. Application Data
(60) Provisional application No. 61/725,503, filed on Nov. 13, 2012.

(51) Int. Cl. G01N 27/333; H01B 7/00

(52) U.S. Cl. CPC G01N 27/333; H01B 7/00
USPC 204/406; 204/416; 204/413; 174/28

(57) ABSTRACT

In the present invention, the solid contacted ISE and the solid contacted reference are based on a conductive porous network with a solid contact and membrane disposed thereon. The porous networks are not only mechanically stable, but also provide pore structure for the solid contact and membrane to intercalate, which enhances the life time and stability of the sensors. The invention further incorporates a unique fluidic fitting sensor and sealing mechanism so that measurements can be taken at high pressures. The fitting design has many benefits, such as low cost and disposability, which allows them to be mass manufactured. These sensors can be produced for detection of many different kinds of ions by applying different types of ion selective membranes, including polyvinylchloride (PVC) based ion-selective membranes and fluorous matrixes based ion-selective membranes.

This application claims the benefit of provisional Patent Application Ser. No. 61/725,503 filed on Nov. 13, 2012

### FEDERALLY SPONSORED RESEARCH

Work relating to this document was supported in part by grants from the National Science Foundation (1113251). The United States government may have certain rights in the subject matter of the invention.

### FIELD OF THE INVENTION

The present invention relates to devices for quantitatively and selectively measuring ionic analytes.

### BACKGROUND OF THE INVENTION

Membrane based ISEs have been thoroughly reviewed by Buhlmann (Buhlmann, P., Chen, L. D. Ion-Selective Electrodes with Ionophore-Doped Sensing Membranes” In Supramolecular Chemistry: From Molecules to Nanomaterials; Steed, J. W.; Gale, P. A. Eds.; John Wiley & Sons, Ltd: New York, 2012; Vol. 5, 2539.) which is fully incorporated into this patent by reference. Traditional membrane based ISEs typically incorporate a polymer membrane, an optional plasticizer, a selective element to bind with the ion of interest, and an optional counter-ion salt. Recently, Buhlmann and Boswell (US 2008/0293997) have disclosed the use of fluorous membrane based ion selective electrodes for the selective measurement of ions in solution. These sensors show an improved measuring range, improved selectivity, and reduced fouling.

Ion-selective electrodes (ISE) are well established analytical devices which are used to determine the concentration of specific ions by comparatively simple measurements of electrical potentials with a voltmeter. Over a billion measurements were performed with ISEs per year in clinical assays. The technique has also found utility in environmental analysis, process control and food industry.

The conventional ISE construction includes both a working and reference electrode and a voltmeter that measures the potential difference between the two electrodes. The working electrode is comprised of an inner filling solution separating the ion-selective membrane from an internal reference such as a AgCl-coated silver wire. The reference electrode is constructed similarly except, the inner filling solution is in direct contact with the sample via a flowing junction known as a salt bridge. This configuration is very versatile and can be easily set up in the laboratory, it but brings along a number of disadvantages. First, due to the flowing liquid junctions and inner filling solutions, the system is insufficiently resistant towards high pressure as encountered in sterilization or under pressurized conditions including hydrostatic pressure or hydrodynamic flow. Unstable response of these sensors is also caused by evaporation of the inner filling solution or the occurrence of osmotic pressure differences across the ion selective membrane. The latter is a major factor limiting the miniaturization of ISEs. Moreover, transmembrane ion fluxes worsen detection limits and can only be suppressed with careful optimization. Consequently, the development of solid state electrodes with a ion selective membrane directly attached onto a solid substrate has attracted considerable interest.

Some of the earliest examples of solid state electrode designs were reported the early 1970s. In these cases, the ion selective membrane was directly applied to a metal wire (Cattrall, R. W. and Hamilton, I. C., Coated-Wire Ion-Selective Electrodes. Ion-Selective Electrode Reviews, 1984. 6(2): p. 125-172). These designs produced unsatisfactory results because the phase boundary potential at the membrane/metal interface of the coated-wire ISE is poorly defined leading to a drifting response and calibration slope. Further, formation of a water layer at the metal-membrane interface leads eventually to memory effects and, after delamination of the sensitive membrane, to catastrophic failure.

To control the phase boundary potential at the interface between the ion-selective membrane and the conducting substrates, ion-to-electron transducers, referred to as solid contacts, were introduced. Conducting polymers, with both ionic and electronic conductivity, were employed as solid contacts in the early 1990s. Among them, the most widely used and well studied conducting polymer are poly(octyl thiophene) (POT) and poly(3,4-ethylenedioxythiophene) (PEDOT).

As previously mentioned, a external reference electrode is needed to make an ISE measurement. The conventional reference electrode is comprised of a silver/silver chloride electrode that is placed in contact with the sample through a salt bridge filled with an aqueous electrolyte solution. Ideally, the high concentration of ions (3 M KCl) in the salt bridge dominates the liquid junction potential at the interface and therefore, provides sample-independent potential. However, the salt bridges can be contaminated by sample ions and get clogged by particulate matter from the sample matrix, resulting in slow responses and erratic liquid junction potentials. A limiting factor for the use of a salt bridge is also the eventual loss of the electrolyte into the sample, in particular in the case of miniaturized devices or when contamination of the sample with a salt bridge ion interferes with the detection of target ions at very low concentrations. Therefore, liquid-junction free reference electrodes are desired. Several researchers have disclosed the use of hydrophobic polymeric membranes doped with lipophilic salt tetrabutyl ammonium tetrabutyl borate (TBA-TBB) (Mattinen, U., Bobacka, J., Lewenstam, A., Solid-Contact Reference Electrodes Based on Lipophilic Salts, Electroanalysis, 2009, 21(17-18): p 1955-1960) or ionic liquids (Kakiuchi, T., Yoshimatsu, T., and Nishi, N., New class of Ag/AgCl electrodes based on hydrophobic ionic liquid saturated with AgCl. Analytical Chemistry, 2007, 79(18): p. 7187-7191.) Utilizing the same conducting polymer developed for solid contact ISE, solid contacted reference electrodes were developed. Combined with solid contacted ISE, an all solid state potentiomentric sensing system was proposed in work done by Salzitsa Anastasova-Ivanova, et al. (Anastasova-Ivanova, S., et al, Development of miniature allsolidstate potentiometric sensing system, Sensors and Actuators B: Chemical, 2010, 146: p 199-205). However, in this work, gold was used as the substrate. Poor adhesion of the conducting polymer to the gold substrate results in mechanical failure and short life time.

One advantage of an all solid state potentiometric system is that it is more readily amenable to miniaturization so that multi-ions can be measured simultaneously. For example, a disposable self-calibrating electrode apparatus is disclosed in U.S. Pat. No. 481,439. The disclosure describes a flow cell with a disposable cartridge containing a sensor or bank of sensors. The ISE sensor in this work is an ISE membrane coated silver wire, while the reference electrode is silver wire with liquid junction. This causes problems for reproducibility and stability as mentioned above.

Mercedes Vázquez et al (Vázquez, M., et al, Small-volume radial flow cell for all-solid-state ion-selective electrodes, Talanta, 2004, 62: p 57-63) describe the fabrication of two ISE flow cells with built in solid contact ISEs based on conducting polymers. In the first flow cell, the solid contact substrate was described as a gold or a carbon polymer composite. The gold has poor adhesion to the solid contact layer. The carbon composite is not amenable to fluidic sealing between the fitting and the composite, and thus produces a leaky fitting when fluidic pressure is applied. Further, the composite will swell in the presence of plasticizing solvents or oily matrices, thus causing drift and a decline in reproducibility. In addition, the composite is directly connected to a wire leading to the voltmeter. This causes problems with installation of the sensor fitting into the manifold as the wire inevitably rotates with the fitting as it is screwed into the manifold. Since they do not rotate independently, the design is prone to failure of the electrical connection between the wire and the composite. To solve the problem, in the second flow cell, sensing membrane was permanently attached to a fluidic manifold. This attachment prevents convenient replacement of the ISE apparatus independent of the fluidic manifold.

Sensor fittings have been employed as detectors for chromatography as is reported in Ion-selective electrode potentiometric detection in ion-chromatography (Isildak, I., Covington, A. K., Electroanalysis, 1993, 5: 815-824). However, coated wire ISEs are used instead of conducting polymer based solid contacted working electrodes and reference electrodes. Furthermore, fluidic sealing systems that are miniaturized and allow a low dead volume within the chromatographic system has been a key limiting issue.

### SUMMARY OF THE INVENTION

### Brief Description of the Drawings

FIG. 1 illustrates a diagram of a ion-selective membrane based ion selective electrode assembly of the prior art that is immersed in a sample and is used for measuring ions in a sample.

FIG. 2 is a cross sectional view of the ion selective electrode system of the device of the present invention.

FIG. 3 illustrates a ion selective electrode fitting embodiment of the device of the present invention.

FIG. 4 illustrates a multichannel assembly embodiment of the present invention.

FIG. 5 illustrates an embodiment of the present invention constructed from a venous catheter.

FIG. 6 illustrates a electrical connector embodiment of the present invention.

FIG. 7 illustrates a fluidic system device of the present invention incorporating sensor element assemblies and debubbling apparatus.

FIG. 8 illustrates a fludic system incorporating the fluidic assembly device of the present invention.

FIG. 9 illustrates a simple membrane gas removal device of the present invention.

FIG. 10 illustrates a high impedence device of the present invention for recording data from sensor elements.

FIG. 11 illustrates an alternative fluidic system embodiment of the present invention incorporating sensor element assembly and a fludic assembly device into a high pressure liquid chromatography fluidic path.

FIG. 12 illustrates low loss coaxial cable of the prior art.

FIG. 13 illustrates low loss coaxial cable of the present invention that utilizes organic semiconductor coatings as shielding and grounding layers.

FIG. 14 is a graph that illustrates the response from a chloride ion selective sensor of the present invention.

FIG. 15 is a graph that illustrates a PFOS sensor of the present invention.

FIG. 16. shows real-time response for PFOS⁻ with an ISE based on membranes consisting of tetraalkylphosphonium cation 1 (0.25 mM) and electrolyte salt (1 mM) in perfluoropolyether measured with commercially available datalogger (A) outside Faraday cage or (B) in Faraday cage, or by (C) the datalogger of the present invention.

### DETAILED DESCRIPTION OF THE INVENTION

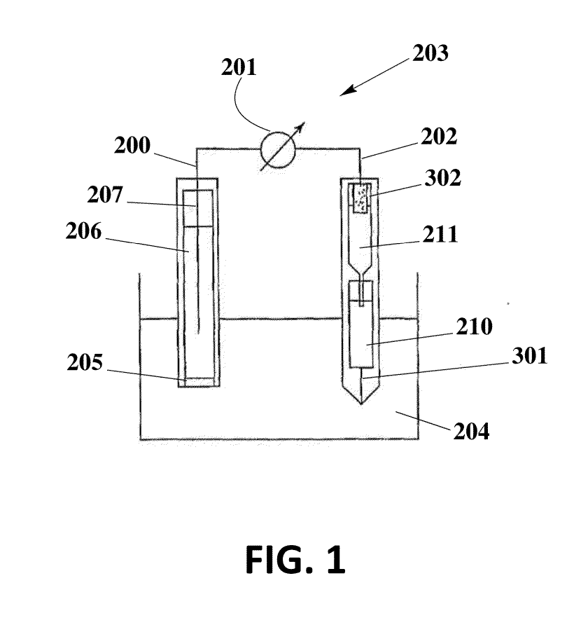

FIG. 1 depicts an electrochemical cell 203 assembly of the prior art comprising a membrane based ion selective electrode 200, a voltmeter 201, and an external reference electrode 202. The ion selective electrode 200 is inserted into the sample solution 204 where the analyte and other matrix chemicals interact with the ion selective membrane 205 to create a complex boundary potential at the membrane liquid interface. The internal reference electrode 207 is in contact with the inner filling solution 206, which is in contact with the ion selective membrane 205 that is in contact with both the inner filling solution 206 and the sample solution 204. The internal reference electrode 207 typically is comprised of a silver wire coated with silver chloride (Ag/AgCl). This electrode can be replaced by another coated electrode material as is readily understood by those skilled in the art. The external reference electrode 202 can be chosen from any typical reference electrode such as is commonly known in the art.

In operation, the electrochemical cell 203 is inserted into a sample solution 204 to measure selected components in the liquid phase. An electromotive force develops between the ion selective electrode 200 and the external reference electrode 202 which is measured with a voltmeter 201. Since the membrane is selective for the target ion, the voltage measured will indicate the presence of the target ion in sample solution 204.

The inner filling solution 206 typically comprises a mixture of the target ion dissolved in a buffer. The freshly produced ion selective membrane 205 is typically exposed to inner filling solution 206 and is equilibrated and aged in a sample solution 204 that significantly matches the composition of the inner filling solution 206. Typically the inner filling solution 206 is buffered and can contain primary ion and/or one or more potentially interfering ions to reduce the effect of transmembrane fluxes on the measured signal. The inner filling solution 206 can also incorporate a number of ion exchangers, anti oxidants, or buffers that will stabilize the inner filling solution 206 or provide a chemical sponge for primary ion or potentially detrimental reaction products that may be produced over time.

An external reference electrode 202 incorporates a liquid junction 301 between the bridge electrolyte solution 210 and sample solution 204. In this case, the reference electrode internal electrode 302 is immersed in a reference electrolyte solution 211. This liquid junction 301 can be comprised of various inert porous materials including porous ceramics, porous glass, porous polymers, and porous metals. Alternatively, a porous polymer or silica monolith may be cast and cured. The purpose of this configuration is to prevent the bridge electrolyte solution 210 from reacting with and fouling the electrode surface. This liquid junction 301 provides a tortuous path for diffusion and significantly increases the time for the bridge electrolyte solution 210 to migrate through the liquid junction to the sample solution.

One embodiment of the present invention uses a Ag/Ag2S internal reference electrode 207 and a Ag/Ag2S reference electrode internal electrode 302 to make the respective internal references less susceptible to chemical attack by inner filling solutions 206 that might react with it. Inner filling solutions 206 could react with AgCl, resulting in undesirable reactions of the components in these inner filling solutions. Such reactions include oxidation and desulfurization. Importantly, a slow decrease in the inner filling solution ion concentration results in a shift in the phase boundary potential at the interface of the inner filling solution of the ISE and the ion-selective membrane. For example, xanthate desulfurization by AgCl will gradually convert AgCl to Ag₂S, resulting in changes in the phase boundary potentials between (a) the silver precipitate and the Ag wire and (b) the silver precipitate and the inner filling solutions. Shifts in these three phase boundary potentials will manifest themselves (a) in a slow drift of the measured potentiometric response, requiring frequent recalibration, and (b) in an increased temperature sensitivity of the calibration curve due to the resulting differences between the internal reference electrode and the external reference electrode relative to which the potential of the ISE is measured. Therefore, a reference electrode design based on Ag₂S-coated Ag wires is an alternative embodiment. It is anticipated that other embodiments using other electrode materials and their sulfide coatings could be used as alternative internal reference electrodes 207.

Using Ag₂S-coated Ag wires as internal reference electrodes 207 eliminates the driving force for desulfurization. Solid-state ISEs based on Ag₂S for the measurement of sulfide and Ag⁺ are well established and take advantage of the high conductivity of Ag₂S [Koebel, M.; IbI, N.; Frei, A. M., Conductivity and kinetic studies of silver—sensing electrode. Electrochimica Acta 1974. 19: p. 287-95], which is about three orders of magnitude higher than that of silver halides, and the very low solubility of Ag₂S (solubility product, Kₛₚ, 4.3×10⁻⁵⁰, as compared to 1.6×10⁻¹⁰ for AgCl). As all suitable setups for external reference electrode and internal reference electrodes, the Ag₂S/Ag system has a very small temperature coefficient (reported to be in the range of −0.04 to −0.08 mV/° C., as compared to −0.08 mV/° C. for AgCl/Ag).

In an another embodiment, external AgCl/Ag reference electrode internal electrode 302 is replaced with a Ag₂S/Ag-based reference electrode because (a) identical reference electrode internal electrode 302 and internal reference electrode 207 minimizes the temperature dependence of the measured EMF, and (b) because this eliminates complications and improves real-life lifetimes due to sulfide and hydroxide from samples diffusing past the liquid junction 301 into the bridge electrolyte solution 210 of the reference electrode, leading there to the reaction of AgCl to Ag₂S or Ag₂O.

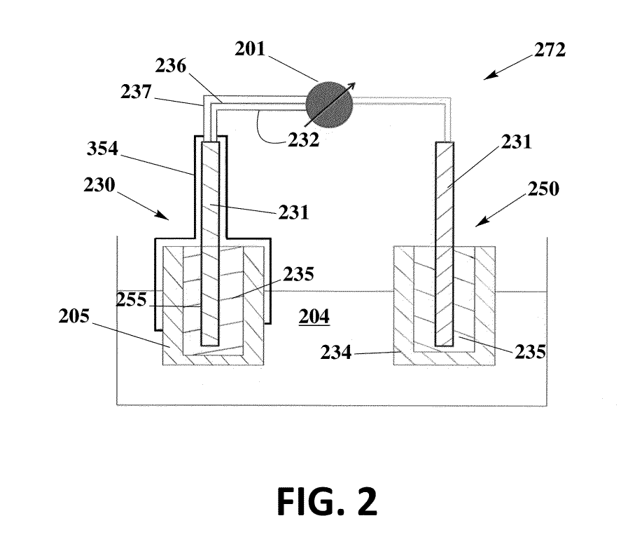

FIG. 2 of the present invention is an alternative embodiment to the electrochemical cell described in FIG. 1. The ion selective electrode system 272 is comprised of a working electrode 230 and a external reference electrode 250. Similar to the electrochemical cell in FIG. 1, a voltmeter 201 is used to measure the potential between the working electrode 230 and the external reference electrode 250 when brought into contact with the sample solution 204.

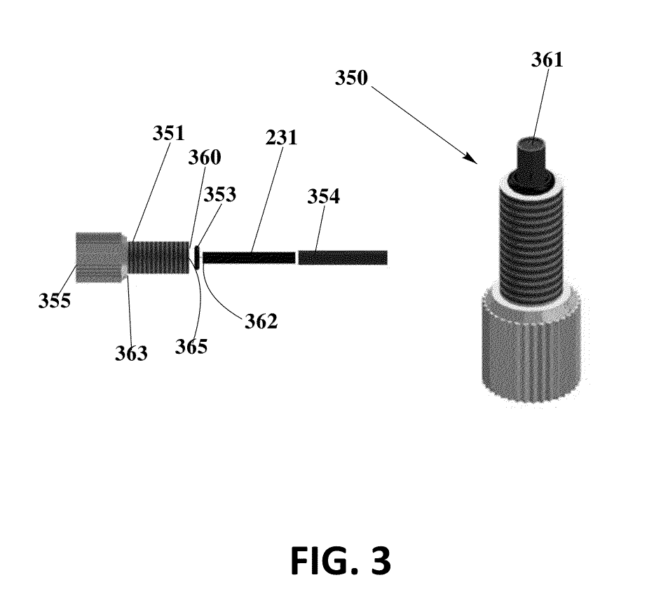

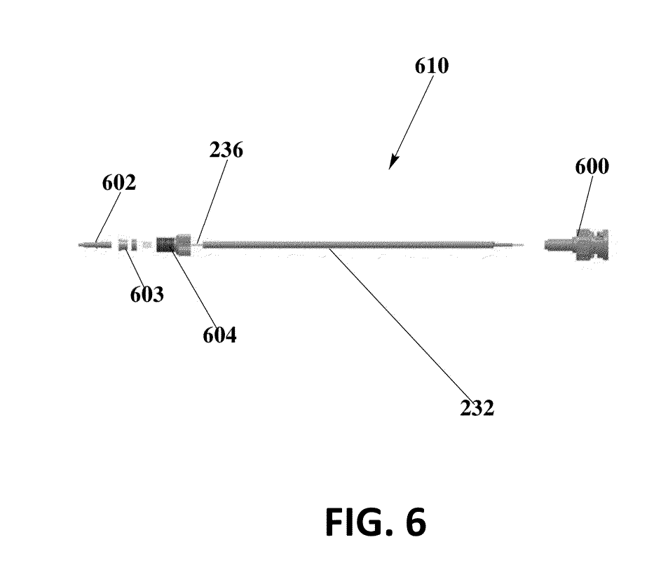

Now with particular attention to the working electrode 230, the electronically conducting member 231 is attached to the central conductor wire 236 of a low loss coaxial wire 232. The central conductor wire 236 be can be stranded or solid wire and is typically constructed from copper or silver coated copper. Solid vs stranded central conductor wire 236 wires tend be more electrically stable and an air gap between the central conductor wire 236 and the shield 237 can deliver superior performance. The connection between the central conductor wire 236 of the low loss coaxial wire 232 and the electronically conducting member 231 can be made with any number of crimping or gluing methods as is commonly known in the art. Appropriate glues include silver or carbon filled epoxy. In the case of epoxy, appropriate curing time and good adhesion to both the central conductor wire 236 of the low loss coaxial wire 232 and the electronically conducting member 231 is required to prevent an electrical short or a highly resistant electrical connection. The requirements for this connection include adhesion and sufficient conductivity so as to not significantly contribute (i.e. <<1%) to the overall electrical resistance. Total electrical resistance of the connection between the electronically conducting member 231 and central conductor wire 236 wire of the low loss coaxial wire 232 should typically be less than 1 k ohm. In some cases, during use, the coaxial cable 232 needs to rotate independent of the working electrode. This requires a different central conductor wire 236 to electronically conducting member 231 design as will be discussed in FIG. 3 and FIG. 6. The electronically conducting member 231 can also be directly soldered to the instrumentation amplifier of voltmeter 201, preventing losses due to connections.

Now, the electronically conducting member 231 can be fabricated from many different materials. The key feature is to provide a conductive porous network 255 disposed within and or upon the surface of the electronically conducting member 231. In one embodiment in the present invention, it is fabricated from iso molded graphite carbon rods. To make the rods, graphite is ground and exfoliated in an organic dispersant or binder with subsequent extrusion/molding. Organic dispersants include glues of organic origin such as polyester or acrylate oligomers and monomers. The rod diameter ranges from 0.1 mm to 200 mm in diameter. The carbon that makes up the rod is typically graphitic and is mixed with a binder such as epoxy or polyester or clay and extruded, molded, or cast into rods or flat ribbons. The rods are porous with a large pore size distribution; pores range from 1-100 nm. The porosity can be increased by removing the organic (non clay) binder at 500-1000° C. One commercial product that is suitable as a substrate is fine isomolded graphite carbon rods obtained from the GraphiteStore.com. Isomolded rods tend to be more consistently electrically uniform compared to extruded rods. However, extruded rods provide acceptable performance if the carbon is fine enough and the binder content is low.

In some cases, it is preferred that the working electrode 230 be encapsulated disposed between insulative substrates. In this case the electronically conducting member 231 is a thin conductive film that is covered with solid contact member and membrane respectively. The thicknesses of the conductive trace can range from several microns to several hundred thousandths of an inch. The film is typically solution cast or printed onto a inert substrate that can be selected from any number of plastics that will provide good adhesion to the central conductor body and good insulating properties. Encapsulation of conductive traces by an insulative substrate is commonly practiced in the art.

The thin conductive film may be an ink formulated from graphite, buckyballs, nanotubes and fluorinated versions of these materials can be used provided it is compounded at a high enough percentage to provide electron transport and acceptably low resistance. Ink formulations include a solvent, a solid conductive material, an optional nano dimensioned porogen, and an optional binder. For example, carbon can be compounded up to 70% w/w in an acrylate formulation comprising a oligomer, a monomer, and a photoinitiator and photocured with UV light. There are many such formulations found in the art. An example formulation includes 50% exfoliated graphite, buckyball, or carbon nanotubes, 10% isobornyl acrylate, 5% 2,4 diisocyanato-1-methyl-benzene, and 20% 2-methyl, 2-hydroxyethyl, 2-propenoic acid. Nano sized porogens include polymers, carbon, and metals and are available for purchase at Sigma Aldrich nano materials. A wide variety of nanoparticles are available from Sigma Aldrich. Alternatively, nanoparticles such as sliver nanoparticles can be introduced into the matrix and may or may not be removed upon curing. Nanoparticles that have been selected and/or prepared to achieve or produce a particular property in the resulting electronically conducting member 231, are intended to be within the scope of the present invention. For example, nanoparticles that may be used herein include well-known nanoparticles that have been made from metals (for example, Pd, Cu, Fe, Ag, Ni), intermetallics (for example, Al₅₂Ti₄₈), and metal oxides (for example, TiO₂, Y₂O₃, ZnO, MgO, Al₂O₃). In certain embodiments, the nanoparticle is crystalline or amorphous. Other anticipated nanoparticles include carbon based nano materials such as graphene, nano tubes, or buckyballs. Graphite may or may not be exfoliated as is commonly described in the art. The binder such as epoxy or poly urethane can be optionally removed after casting and curing at 1000° C. under nitrogen to make nano dimensioned pores which allow for high capacitance and direct ion to electron transduction. There are a wide variety of inks that are formulated with carbon that are also suitable for porous or nonporous conductive carbon coatings.

In another embodiment, the electronically conducting member 231 is fabricated from a porous metal conductor or a metal ink containing a porogen. High quality metal coated pins are not usually sufficient to maintain adhesion between the solid contact member 235, and the electronically conducting member 231. The nonporous metal conductors can be made porous by treating the metal pin surface with porous metal particles or metal nano particles with subsequent annealing to provide adhesion. Metal frits are suitable and are the preferred embodiment because they offer a off the shelf porous metal option. The porous metal may be electroplated with any suitable inert metal.

The electronically conducting member 231 may or may not have a ion to electron transducer, referred to as solid contact member 235. In some cases where the porosity of the electronically conducting member 231 is closely controlled around a monodisperse 100 angstroms, the solid contact member may not be required. This can be accomplished using a layer of porous particles that have monoporosity such as carbon coated silicas as are commercially available from United Science. The solid contact member 235 can be conducting polymers. An example of a conducting polymer is polyoctylthiophene (POT) with a average MW of 10,000-60,000 daltons. Other examples include poly(3,4-ethylenedioxythiophene), poly(thiophene-3-[2-(2-methoxyethoxy) ethoxy]-2,5-diyl) or polypyrrole or any number of conductive coatings. Typically, the organic semiconductor is dissolved in carbon tetrachloride and is cast on the electronically conducting member 231 dropwise. The carbon tetrachloride evaporates leaving the electronically conducting member 231 coated. Several coatings are required to fully coat the central conductor body uniformly.

The solid contact member 235 can be a metal transducer comprised of metal redox pairs. Metal redox pairs include ferrocene/ferrocenium redox couple, cobalt(II)/cobalt(III) redox couple, Au cluster and any other metal redox couples. Typically, these redox pairs are dissolved into tetrahydrofuran with into ion selective membranes 205 and drop casted onto electronically conducting member 231. The tetrahyrofuran evaporates leaving the electronically conducting member 231 coated. Several coatings are required to fully coat the electronically conducting member 231 uniformly. The solid contact member 235 may be mixed with membrane 234 or membrane 205 to provide a continuous single phase.

When the electronically conducting member 231 has a high enough surface area such as is found with nano porous carbon materials described above, then the solid contact member 235 may not be needed to obtain a stable Nernstian response.

With respect to ion selective membrane 205, any coating that is described in the art may be used. The membrane may be based on fluorous matrixes or may be based on hydrocarbon polymeric membranes as is described in the art. Typically, the membrane is cast dropwise over the end of the electronically conducting member 231 that is coated with organic semiconductor. Up to three coats with 1-2 hr cure time in between may be required to provide a consistent pin hole free coating.

If the electronically conducting member 231 is porous, care must be taken to allow penetration of the membrane mixture into the pores for adhesion and larger surface area contact. This can be accomplished by vacuum and sonication.

With respect to external reference electrode 250, external reference electrode 202 as described in FIG. 1 will suffice. However, in certain circumstances, the reference electrode can follow the same construction as working electrode 230 is discussed in FIG. 2. However, the reference electrode membrane 234 should not be selective for any particular ion of interest as is ion selective membrane 205. These membranes are commonly based on lipophilic salts, such as tetrabutyl ammonium tetrabutyl borate (TBA-TBB) or ionic liquids, such as 1-methy-3-octylimidazolium bis-(trifluoromethylsulfonyl)imide ([C8mim+][C1C1N−]). The reference electrode membranes 234 are coated in the same way as is ion selective membrane 205.

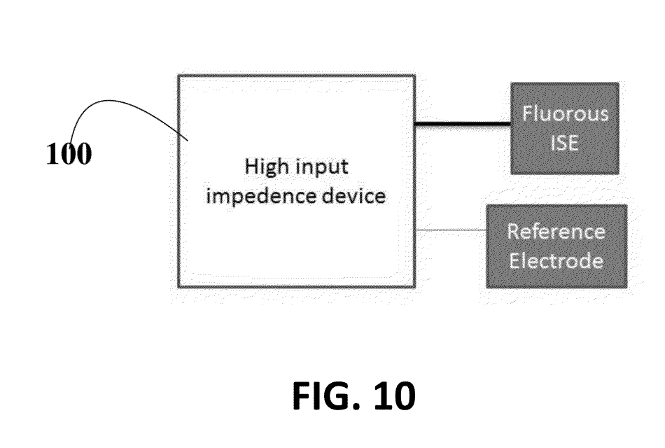

This basic electrode design can be used to create some highly useful ion selective sensors. FIG. 3 shows a sensor fitting 350, comprised of a ¼-28 threaded fitting 351, a electronically conducting member 231 coated with solid contact members 235 as described in FIG. 2, resilient polymeric member 354, and an fluid sealing member 353. In this case, the electronically conducting member 231 is a nano porous, iso molded graphite carbon rod, which has been machined to maintain the outer diameter dimension to within +/0.001, −/0.000 inches. The resilient polymeric member 354 is made of heat shrink PVC, FEP, or PTFE. A through hole 365 in the ¼-28 nut 351 has been machined to allow a 0.0005-0.003″ compression fit of the heat shrink encapsulated electronically conducting member 231. The distal end 355 of the ¼-28 threaded fitting 351 as been threaded to receive a coaxial cable assembly 610 (FIG. 6) that will transmit the sensor signal to the high input impedance device 100 of FIG. 10.

The electronically conducting member 231 is either pressed into the nut or is pulled through the hole 365 of threaded fitting 351. The pull through procedure involves shrinking an extended length of resilient polymeric member 354 onto the electronically conducting member 231. The shrink tubing is then pulled through hole 365 from the distal end 355 to the proximal end 360. The extended piece of resilient polymeric member 354 that pulled the electronically conducting member 231 through the nut is then trimmed with a diamond razor blade and the carbon polished before adding the solid contact member and membrane to face 361. Subsequently, the ion selective membranes 205 or reference electrode membrane 234 are applied to the first sensor face 361 of the electronically conducting member 231. The rod may protrude from the face of the proximal end 360 or it may be flush with the face depending on the requirements of the receiving device. The fluid sealing member 353 provides a fluidic seal between the analysis fluid and the outside of the device. Suitable sealing members include ferrules, o-rings, or chisel points.

It should be noted that the membrane 205 can partially dissolve this resilient polymeric member 354 when it is cast on the face 361, thereby producing a fluid tight seal. Alternatively, polymeric matrix can be coated on the inside of a tube that the membrane is not soluble in. Then, when it is cast onto face 361, it will dissolve into the coating that has been coated onto the non-soluble resilient polymeric member. Such non-soluble resilient polymeric member 354 may include PTFE or FEP. This coating effectively acts like a glue.

The fitting 350, can be any threaded or non threaded nut commonly described in the art. Threaded nut examples include 10-32 threaded nuts, ¼-28 nuts, and Swagelok hardware including all metric equivalents. The fitting 350 can be a threaded nut made from stainless steel, Tefzel, PEEK or any other material commonly used in the art. It is anticipated that the sensor could be adapted to any common fluidic fitting including quick disconnects and Luer nuts. The fitting 350 need not be threaded provided there is sufficient axial and radial compression to prevent leakage. A pressed in fitting 350 with no threads is desirable from the standpoint that there is no radial torsional force applied to the sensor face 361 which may damage it in the case that the conductor protrudes from face 361. This design can withstand several thousand pounds of hydrostatic pressure and not leak.

The fluid sealing member 353 sealingly engages the fitting 350 to a female threaded or non threaded seat that is commonly known in the art. The fluidic seal can be accomplished with a coned ferrule or flangeless fitting or super flangeless fitting as is commonly known in the art. The materials are understood to cover the full range of materials commonly known in the art such as stainless steel, PEEK, PTFE, FEP, and combinations of these materials.

Quick disconnect fittings such as are commercially available from Colder Products, are desirable to eliminate the need to rotate the fitting to thread it into a receiving seat. Rotation torsional force applied to the face 361. In this case, it is understood that the assembly technique and the fabrication materials can be altered to accommodate any diameter fitting.

The electronically conducting member 231 can be made from any material that satisfies the criteria set forth in the discussion of FIG. 1. The length of the electronically conducting member 231 can vary as mentioned above. Upon installation, the distal end 362 of the electronically conducting member 231 should align with thread location 363. This is necessary because the coaxial cable threads into end 355. If the electronically conducting member 231 is too short, the electrical connection will fail and the ISE will not work.

The resilient polymeric member 354 material should be selected to provide chemical compatibility with the fluid and adhesion to the ion selective membrane or reference electrode membrane. The wall thickness of the tubing typically ranges from 0.001 to 0.010″. The thicker the wall, the greater the compliance for pulling or pressing the electronically conducting member 231 into the through hole 365.

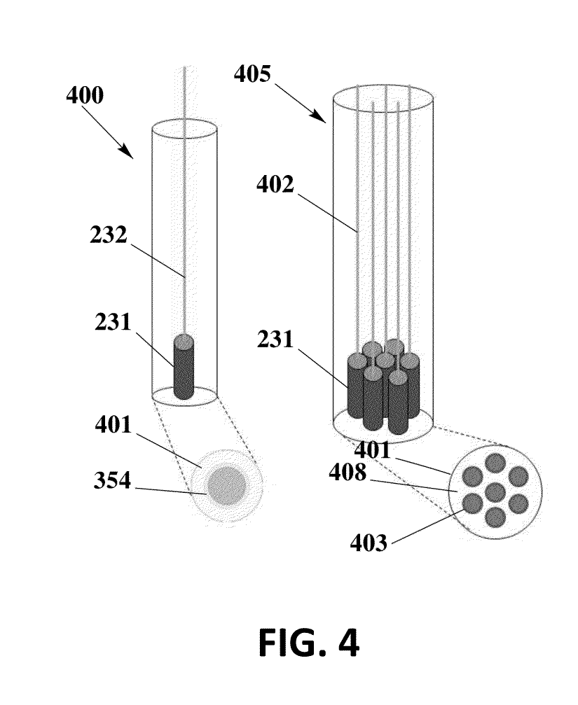

FIG. 4 shows an example of an additional embodiment. Assembly 400 is a single sensor comprised of a electronically conducting member 231, coaxial cable 232, resilient polymeric member 354, and a protective housing 401. The electronically conducting member 231 follows the construction guide outlined in FIG. 1. Electrical connection of the coaxial cable 232 to the electronically conducting member 231 will also follow those guidelines established in the specification under FIG. 1. Methods and assemblies for improved shielding of the electronically conducting member 231 can follow the guide given in the discussion of FIG. 1. The method of assembly and variations follow the guidelines outlined in the discussion around FIG. 3. However, it is important to note that the resilient polymeric member 354 can extend to cover the electronically conducting member 231 to cable connection and can extend to cover the entire length of the coaxial cable 232. The protective housing 401 can be any resilient or non resilient material including stainless steel, PVC tubing, PEX tubing, PTFE tubing or any other material that provides protection to the sensor.

Multi-lumen sensor assembly 405 is a muli sensor design similar to assembly 400. The construction comprises a plurality of insulated electronically conducting member 231, a plurality of electrical cables 402. The electrical cables 402 may be combined into a single mutt conductor shielded cable as is commonly known in the art. The insulation layer 403 provides electrical isolation for electronically conducting member 231. Heat shrink tubing or conformal coatings provide these insulative characteristics. The insulation layer 403 provides a resilient layer around the electronically conducting member 231 to shield and seal the connections to the multi lumen holder. A multi-lumen structure 408 provides the compression on the outer diameter of the electronically conducting member 231. The multi-lumen structure 408 can be made from epoxy, FEP, PTFE, PVC, or any other solution castable potting agent. Alternatively, the multi-lumen structure can be an extruded or machined structure. The outer housing 401 provides a protective body to the sensor array and can be any resilient or non resilient material including stainless steel, PVC tubing, PEX tubing, PTFE tubing or any other material that provides protection to the sensor.

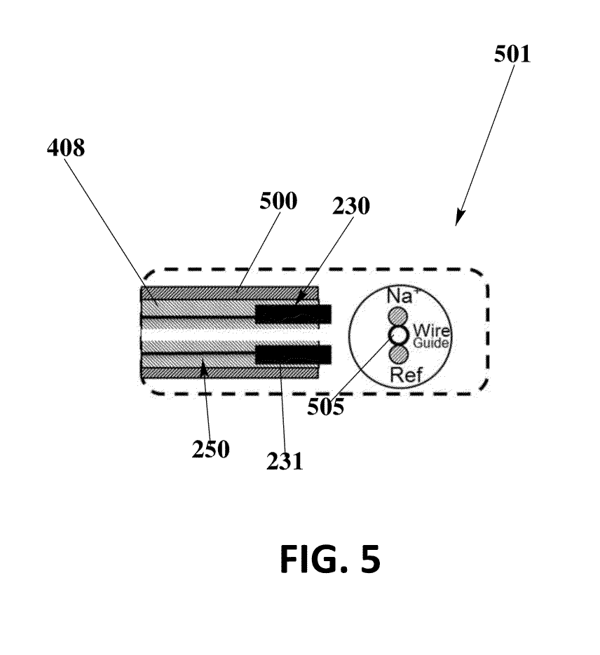

FIG. 5 shows an alternative embodiment of a multi-lumen sensor assembly 405 installed into a multi lumen catheter 500. In this case, a plurality of working electrodes 230 and reference electrode 250 are glued or installed into the lumens 408 of a venous or arterial catheter. A French 22 gage catheter is a commonly used for these purposes. Either glue or compression is used to sealingly engage the electrodes to the catheter 500. Glue can be epoxy, acrylate, or any other glue that allows the insulated electronically conducting member 231 to sealingly engage the catheter 500. Typically, there are a plurality of open lumens 505 for guide wire, drug, liquid or calibration solution delivery to the sensor head location. This catheter assembly 501 can be installed in the superior or inferior vena cava to monitor the onset of hyponatremia during surgery or in the intensive care unit.

FIG. 6 shows an example of an electrical coaxial cable assembly 610 that is used in conjunction with the sensor fitting 350 shown in FIG. 3. It is comprised of a low loss electrical connector 600, low loss coaxial cable 232, a spring loaded electrical connector pin 602, and a fitting assembly comprising a ferrule assembly 603 and a cable assembly fitting 604. The low loss electrical connector 600 can be configured to receive multi conductors or a single conductor. This connector 600 is electrically engaged with the high input impedance device 100 of FIG. 10. The low loss electrical connectors 600 are commercially available from many vendors but the high input impedance device is an object of the present invention. The connector 600 is optionally waterproof. The coaxial cable 232 can be muti-conductor or single conductor. In the case of a single conductor, a single spring loaded electrical connector 602 is soldered to the central conductor wire 236 of the coaxial cable. This spring connector 602 is gold plated and has a high electrical conductivity. The use of a spring loaded pin 602 is desirable since it can accommodate dimensional variances and tolerances in the fitting and in the axial location of the electronically conducting member 231. The pin 602 also allows torsional degree of freedom so that the assembly 603 can rotate around the central axis with out breaking the electrical connection.

The ferrule assembly 603 is crimped onto the outer surface of the connector pin 602 to hold the pin in electrical engagement with the electronically conducting member 231. The ferrule assembly 603 connected to the pin is threaded into the threaded proximal end 355 of sensor fitting 350 to create an electrical connection. The ferrule mechanically engages the distal end 362 of the electronically conducting member 231 providing axial support to the electronically conducting member 231. When the electronically conducting member 231 is large diameter (>1 mm), it is important to provide axial support under high hydrostatic pressures (>3000 psi). High hydrostatic pressure on face 361 can displace the electronically conducting member 231 axially through the threaded fitting 351.

The two piece sensor assembly comprising coaxial cable assembly 610 and fitting 350 is desirable to be used as a single piece design shown in FIG. 4 if a controlled and sealed fluidic interface is required. Examples of fluidic interfaces that benefit from a two piece sensor assembly include a high performance liquid chromatography flow cell, a manifold, a micro fluidic chip, a bioreactor, a process stream or a valve.

In an alternative embodiment, the ISE fitting 350 shown in FIG. 3 can be adapted to give rotational and translational freedom in light of the design shown in FIG. 6. In this case, the electronically conducting member 231 is not compressed within fitting 350 and has translational axial and radial freedom. The electronically conducting member 231 loose within fitting 350 but is spring loaded from the distal end 355 with a spring loaded conductor pin 602 as shown in FIG. 6. The electronically conducting member 231 is pressed by the spring load against a polymeric or PTFE-supported ion sensing membrane that is sealingly attached to face 361.

In the case of PTFE ion selective membranes, they can easily be adhered to nut face 360 with any number of glues or ultrasonic welding. A series of co-radial chisel points can also be machined into the face 360 to provide sealing points for the nut against the receiving seat. This is an important feature for fluidic sealing as rotation of the ISE membrane against a receiving seat is not recommended. Ferrule techniques are also effective at sealing.

The fitting 350 and cable assembly fitting 604 shown in FIG. 3 and FIG. 6 can be completely eliminated with any of these designs. These fittings are only required when a fluidic seal is required or when a two piece disposal sensor design is required such as in single use bioreactor sensing. In the case that no fitting is required, resilient polymeric member 354 is still used to hold and connect the electronically conducting member 231 to an coaxial cable 232. The coaxial cable 232 may be directly connected to electronically conducting member 231 as shown in FIG. 2 or it can be connected with a spring connector as in connector 600.

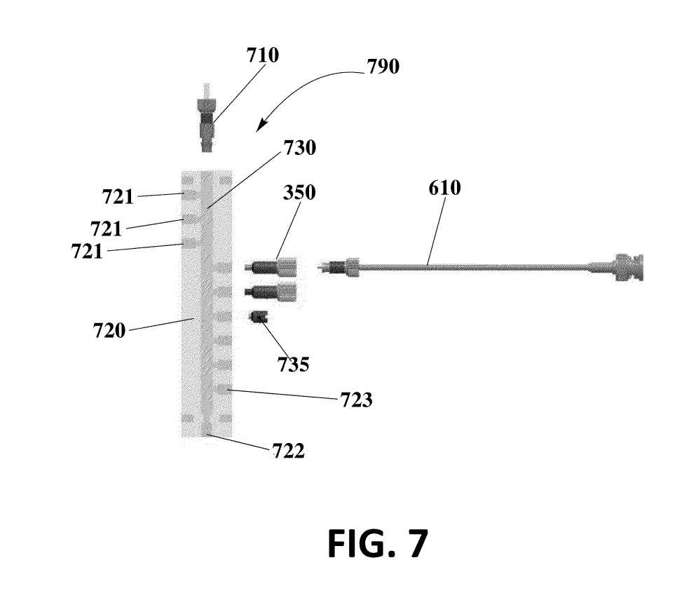

FIG. 7 illustrates a manifold device 790 incorporating a plurality of sensor fitting 350, electrical coaxial assembly 610, hetero phase fluid removal assembly 710, and a fluidic manifold 720. The fluidic manifold 720 has a plurality of inlets 721, outlets 722, and sensor ports 723. The manifold can have a plurality of fluidic channels 730, however, for simplicity, only one channel is shown in this illustration. In this case the channel incorporates a static fluid mixer to provide optimal mass transfer to the sensor. The fluidic manifold 720 can be fabricated from any number of materials including stainless steel or plastics. The inlets 721, outlets 722, and sensor ports 723 can be configured to accommodate many different fitting types and styles from any manufacturer. Unused ports can be sealed with a plug 735.

Hetro phase fluid removal assembly 710 is shown as a press fit assembly. In this case, the hetro phase removal unit is designed to separate immiscible fluids. When oriented properly, fluid entering from inlet 721 that is hetro phaseic, separates in fluidic channel 730. The less dense fluid rises to the top of the manifold when it is oriented vertically and is removed through the removal assembly 710. The removal assembly can be activated by a conductivity sensor or other ultrasonic sensor designed to detect a change in fluid phase.

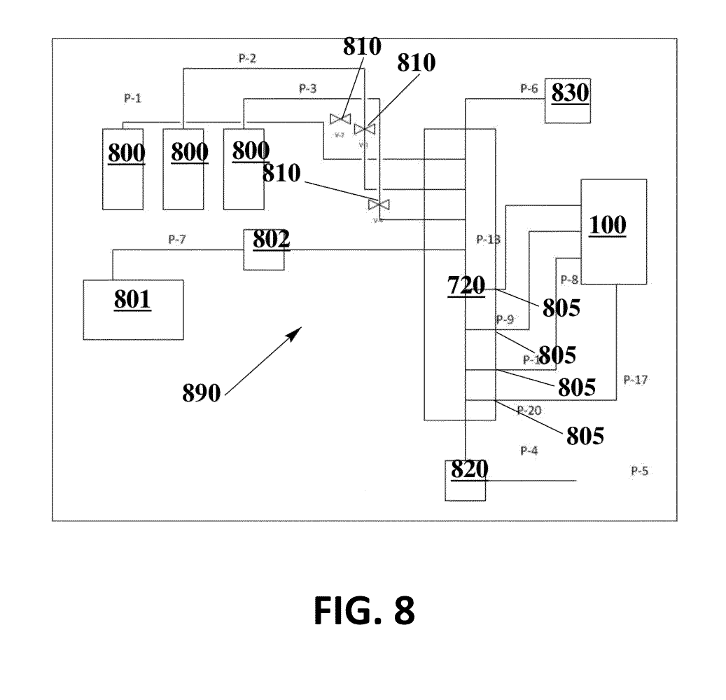

FIG. 8 shows an example of a flexible and configurable fluidic system 890 that utilizes the fluidic manifold 720 detailed in FIG. 7. The system is comprised of fluid reservoirs 800, process fluid inlet overflow reservoir 801, fluid conditioning unit 802, fluidic manifold 720, sensors 805, solenoid valves 810, outlet fluid pump 820, high input impedance device 100, and biphasic fluid removal unit 830. Pumps 820 and valves 810 are actuated and controlled via a configurable routine that is defined by the user. The manifold incorporates grounding channels and temperature measurement channels. These are not shown.

The fluid reservoirs 800 contain buffers, calibrants, and wash solutions. The calibration routine is simple and programmable with a PLC as is commonly used in the art. First, the flow of fluid from the process is shut. The solenoid valve 810 from the appropriate reservoir 800 opens. Pump 820 turns on for enough time to flush the system. The sensor takes a reading. The process is repeated for any number of cleaning, buffering, and calibration routines.

The process fluid inlet reservoir 801 is either a regulated pressure inlet that incorporates a solenoid valve or an overflow sampling reservoir as is commonly used in the art. This second method is preferred. If the process inlet fluid is an overflow sampling reservoir, then unit 802 must incorporate a pump, valve or combination of both to provide fluid flow. Unit 802 preconditions the fluid for the manifold by cooling or heating the fluid. It is desirable that the temperature of the fluid be around 30° C. for most applications. There are many feedback heating and cooling devices on the market that may be implemented to allow cooling and heating. It also incorporates an ultrasonic sensor as is commonly available in the art to detect multi phase fluids.

Unit 802 may also include a nafion membrane pre ion selection.

The process of sampling and measuring the process flow with a sensor 805 is simple and programmable. First, the solenoid valve in unit 802 is opened. Then pump 820 turns on, drawing fluid from overflow reservoir 801, through heater/cooler unit 802 and into the manifold device 790. The device can optionally be flushed with a cleaning solution or calibrant before and after the process is sampled. The pump can oscillate flow forward and backward to maintain a mixed solution provided bubbles do not form. In the case that the fluidic channels are narrow, a pump may be installed between 802 and 790 to provide process fluid to be analyzed under positive pressure.

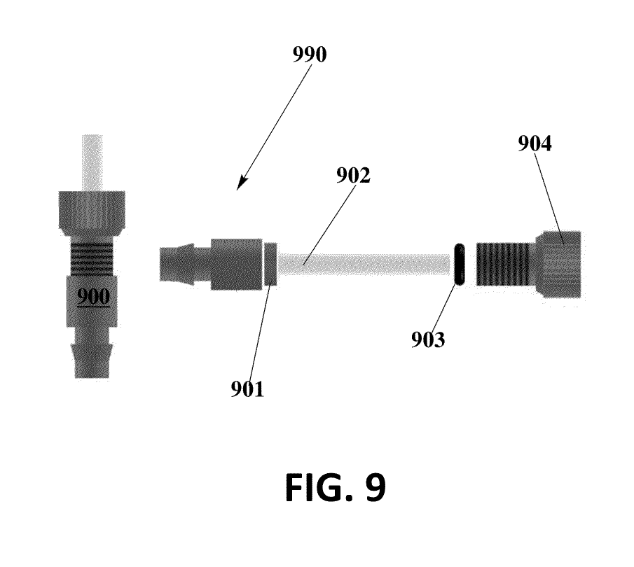

FIG. 9 shows details for the biphasic fluid removal component that interfaces with the manifold. Unit 830 will include a pump that receives a feedback signal from the ultrasonic detector in unit 802. The pump will turn on when the signal threshold is triggered, thus removing the biphasic fluid from the manifold. The ultrasonic sensor could be incorporated onto the manifold if required. Upon pump actuation, the fluid is drawn through the apparatus shown in the figure. The apparatus 990 is comprised of a press in holder 900, a membrane filter 901, a flared tubing 902, an o ring 903, and a fitting 904. The membrane filter is PTFE can can separate gasses from liquids. The pore size of the filter membrane is less than 3 micron. A complete fluidic seal provided by flare tubing 902 and o ring 903 is required for to isolate and sealingly engage the seat in press in holder 900.

FIG. 10 shows a high input impedance device 100 that enables measurement of high impedance samples or high impedance working electrodes. The input impedance of the device is at least 1 teraohm. The device incorporates a high impedance instrumentation amplifier on a ceramic chip. Other infinite impedance devices include optical transmit and readout. Examples of high impedance sensors include those fabricated from highly resistant fluorous membranes. High impedance for the purposes of this disclosure are impedances greater than 100 MOhm. Other sensor membranes with high impedance that may benefit from the device 100 as well. The device 100 can also be used to measure the resistivity of samples that are high impedance such as soil or concrete. The device 100 incorporates a sensor health relay array to occasionally measure the resistance and health of the sensor. The array is comprised of a series of resistors and a series of relays that are sequentially checked to monitor the resistance of the membrane. When the membrane resistance varies over a threshold quantity, then the user is informed that the sensor needs to be replaced.

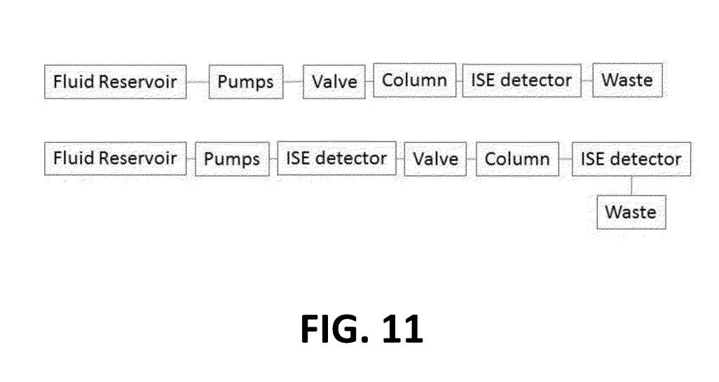

FIG. 11. Describes an application of the devices described above. A chloride selective working electrode, a reference electrode, a high input impedance device 100 and low loss connectors 600 were installed in a low dead volume (5-10 uL) fluidic PEEK “tee” and plumbed into the flow path of a high pressure liquid chromatograph. The chloride detector could be installed on the high pressure side, upstream of the column or on the low pressure side, downstream of the column. It is advantageous to be installed upstream as there is a more accurate real time response and shorter delay time. Furthermore, there is no sample to foul the sensor. A salt gradient from 5% to 100% of 10 mM chloride over 5 minutes was programmed into the chromatograph. The chloride sensor followed the mixing online and in real time. A fluorous PFOS sensor was then plumbed in downstream of the detector and PFC standards were injected onto the column. The PFOS sensor could detect the PFCs upon elution from the column. A pH gradient was programmed into the HPLC unit and monitored using the system and sensor configuration shown in FIG. 11. Step gradients could be detected and monitored in real time.

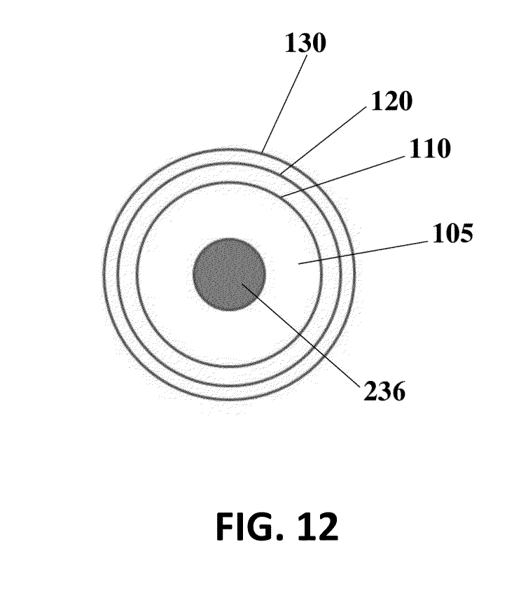

FIG. 12 shows the typical construction of a low loss coaxial cable. The cable is comprised of a central conductor wire 236, an insulator 105, a foil shield 110, a braided wire shield 120, and a jacket 130. The central conductor wire 236 is typically a solid wire of copper coated silver but it can be stranded. The insulator can be any number of materials but is typically PTFE or FEP. It can also incorporate an air gap. The foil is typically silver coated copper or silver foil. The braided wire shield is woven over an additional insulator 105. The jacket covers the braid and protects from external elements.

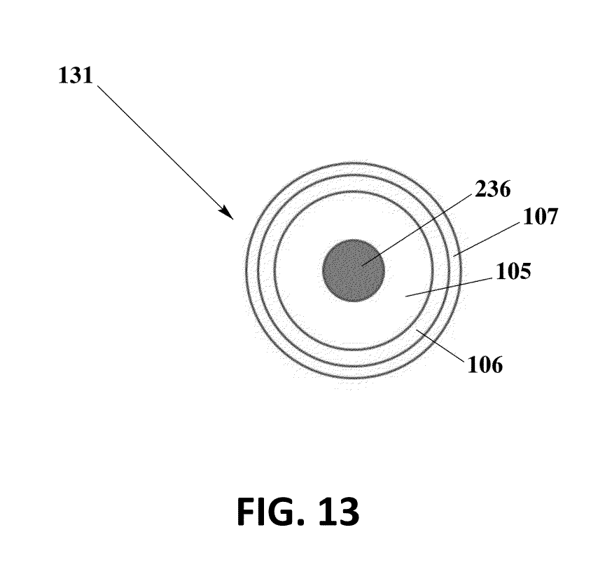

FIG. 13 shows the composite cable 131 of the present invention. This cable uses conductive coatings 106 to replace or augment the metal shields 110 and shields 120 described in FIG. 12. Conductive coatings 106 incorporating single wall nanotubes of different lengths and aspect dimensions dispersed in conducting polymers formulations can be used to reject and shield central conductor wire 236 from various frequencies. This approach can also be used as a general coating for radiation sorption. For example, a formulation of 10 micron length by 1 nm diameter single wall nanotube will disperse a certain frequency of energy. When dispersed in a conducting polymeric layer, it is then useful as a coating that will absorb and drain radiation. A plurality of organic coatings 106 and formulations may be placed on top of one another or be sandwiched between insulators 105. Alternatively, organic semiconductors may be coated to form electron dense or electron deficient coatings. Foam insulators are coated inside and outside to give unique frequency shielding. Coating uniformity is assured by formulation into a UV cure coating 107 or by multi layer coatings. Sprayed or powder coated PTFE nanoparticles can replace most insulators. There are many different types of organic conductors that are soluble in organic solvents. When these are mixed with nanoparticles that will absorb radiation, they can be used in place of metallic shields 110 and shields 120. The coatings 106 eliminate expensive polymer extrusion, wire braiding, and foil operations in some cases.

### Example 1

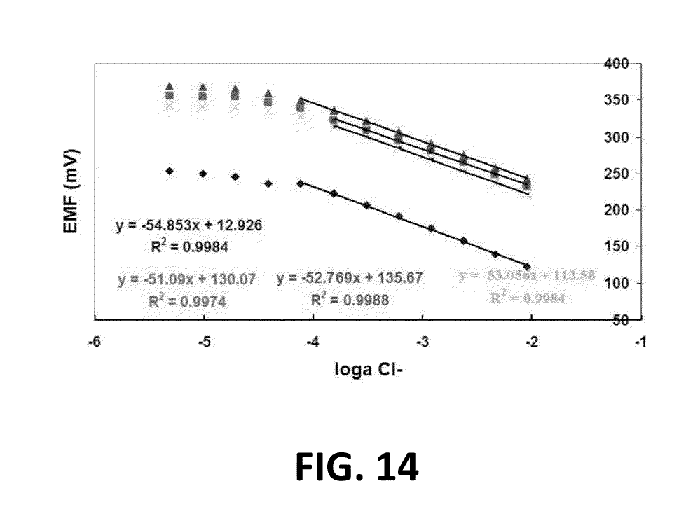

FIG. 14 shows an example of a calibration curve for some of the devices described above. The devices described in FIG. 3, FIG. 6, and FIG. 10 were fabricated. The working electrode was formulated to be selective for chloride. This figure shows that we are able to get a Nernstian response and use the devices with traditional chloride sensing membranes.

### Example 2

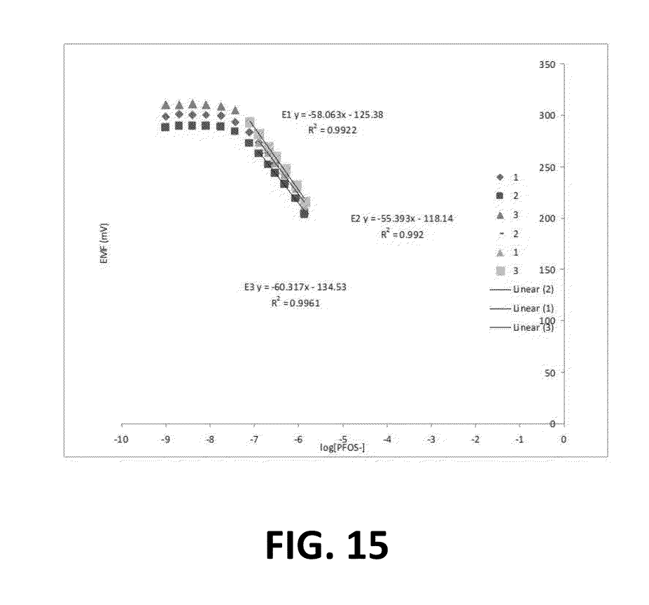

FIG. 15 shows a fluorous sensor for PFOS using the device constructions detailed in FIG. 4, FIG. 6, and FIG. 10. Low limits of detection and Nernstian responses were obtained.

The fluorous ion selective cocktail was applied onto the PTFE membranes.

Cocktail: linear perfluoropolyether solution of 0.25 mM tetraalkylphosphonium and 1 mM electrolyte salt (fluorophilic tetraalkylphosphonium as cation and tetraphenylborate as aninon).

Conditioning process: The electrodes were first condition in 1 μM PFOS-K+ for 2 days and 0.1 nM PFOS-K+ for another 2 days.

The calibration curve was obtained by addition from 10⁻¹⁰ M PFOS-K+. Detection limit was determined as 4.63E-9 M.

### Example 3

The solid contact reference electrode 250 is prepared using an ionic liquid for the potential of miniaturization, elimination of liquid junction 301 and dryness of inner electrolyte solutions, and therefore improvement of performance and lifetime.

To prepare the electrode, a graphite carbon rod (d=7 mm) is inserted into a heatshrink tube to avoid the contact with sample solution and therefore the shortcut. One of its end is soldered with metal wire for the connection to cable. Another end is well-polished and covered with poly(octyl thiophene) (POT) by drop casting its solution (POT is dissolved in chloroform at a concentration of 0.25 mM). After it is dry, new solution is added and this process is repeated for three times. The reference electrode membrane is ortho-nitrophenyl octyl ether (o-NPOE) plasticized poly-(vinyl chloride) (PVC) membrane doped with the ionic liquid 1-methyl-3-octylimidazolium bis(trifluoromethylsulfonyl)-imide (IL). For the best performance, PVC/IL/o-NPOE ratio of 2:1:2 (w/w) is used.

The prepared solid contact reference electrode 250 showed a Nernstian response of with a glass pH electrode which indicates the excellent performance of thus prepared solid contact reference electrode. A similar reference electrode 250 but with different solid contact has been found for excellent potential stability, with potential drifts as low as 42 μV/h over 26 days.

### Example 4

We tested the high input impedance device 100 with a commercially available glass pH electrode. The glass pH electrode was chosen because it had very stable and reproducible response. We monitored the potential of pH electrode at pH 4.0, 7.0 and 10.0 vs a glass double junction reference electrode 202. Theoretical Nernstian response (Slope=58 mV/decade concentration change) was obtained with glass pH electrode in different pH buffers by using the device 100.

### Example 5

We tested the device 100 with prepared fluorous electrodes. All electrodes were solid contact electrodes with carbon rods as solid contacts. The PTFE membranes were glued onto the end of Tygon tubing. There was no polyoctylthiophene (POT) layer between the carbon and the PTFE membrane for electrode 1 and 2 (E1 and E2) and there were POT layers between the carbon and the PTFE membranes for electrode 3 and 4 (E3 and E4). Linear perfluoropolyether solution of 0.25 mM tetraalkylphosphonium cation and 1 mM electrolyte salt (fluorophilic tetraalkylphosphonium as cation and tetraphenylborate as aninon) was applied onto the PTFE membranes. A gold pin, one end of which is in contact with the carbon rod, was soldered to a coaxial cable and connected via BNC connector to a commercially available low input impedance datalogger housed in a Faraday cage or the high input impedance device of the present invention without a Faraday cage. Before measurements, the electrodes were conditioned in 10 nM PFOS⁻K⁺. We used the two voltmeters to measure the PFOS⁻ response of E3, while we spiked in the PFOS⁻ to change the sample concentration. The response slopes were identical.

### Example 6

Noise and real-time response was measured with the glass pH electrode at pH 7.0 using the high input impedance device 100 without a faraday cage. The response reached a stable state in 5 minutes. This is similar to the measurements carried out by commercially available voltmeter in faraday cage. The noise of response was about 0.4 mV.

### Example 7

The response of glass pH electrode in pH 7.0 buffer was continuously monitored with the high input impedance device 100 of the present invention for 2 days. After the response reached a stable value, the long term drift of the electrode was determined to be 5 μV/h.

### Example 8

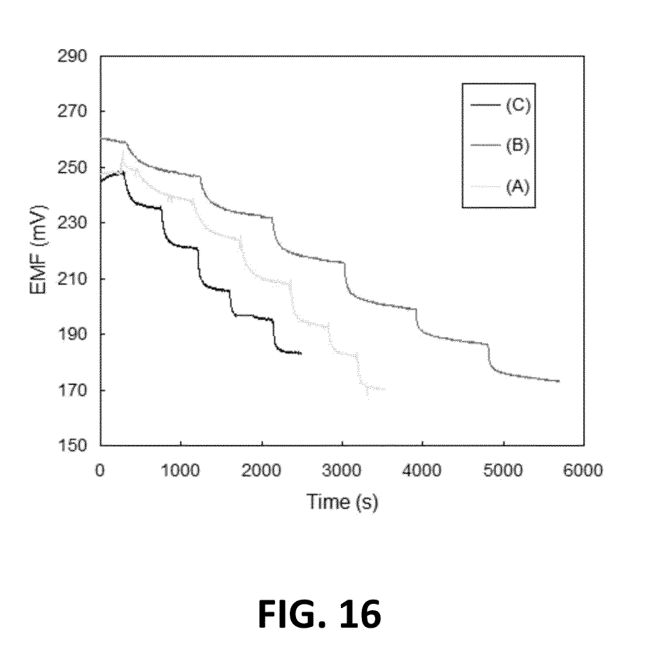

Due to the extremely high electrical resistance of fluorous electrodes, we have to carry out the measurement in a Faradic cage in the past; otherwise, the response of electrode would be very noisy and the response time will be long. But by using the high input impedance device 100 and coaxial cables with low loss connections, the noise was greatly decreased as shown in curve A of FIG. 16 even when measurements were carried out in open air and measured with the commercially available low input impedance voltmeter. Experiment with high impedance voltmeter in the present invention was performed in open air and faradic cage was not used for shielding either. FIG. 16 shows that the response, measured by the high input impedance device (curve C), was more stable with much less noises and spikes compared to the experiment performed with a commercially available low input impedance datalogger without Faraday cage. The noise is about, 0.4 mV, which is at the same level as the response measured in Faraday cage with standard datalogging equipment (curve B). Moreover, after the change of concentrations, we could observe quick change of potentials and achievement of stable potentials in the measurement with high input impedance device. The response times were shorter compared to that using standard datalogging equipment.

### Example 9

Real-timeresponse in 10 nM PFOS⁻ with an ISE based on membranes consisting of tetraalkylphosphonium cation 1 (0.25 mM) and electrolyte salt (1 mM) in perfluoropolyether measured by high input impedance device 100 of the present invention for 2 days. After the sensor was stable, the long drift of the electrode was determined to be 30 μV/h.

1. A electrode comprising:
a. a electronically conducting member, and
b. a solid contact member, and
c. a reference electrode membrane or a ion selective membrane disposed thereon,
d. said conductor body providing a predetermined contiguous electronically conductive porous network whereby said solid contact member and membrane adheres to said electronically conducting member.

2. The electrode of claim 1, wherein said solid contact coating includes a metal redox pair or a semiconducting polymer.

3. The electrode of claim 1, wherein said conductor body is porous carbon or porous metal or porous semiconducting polymer.

4. The electrode of claim 1, wherein said conductor body is substantially homogeneous.

5. The electrode of claim 1, wherein said porous network contains pores from 10 to 1000 angstroms.

6. The electrode of claim 1, wherein said membrane is ion selective.

7. The electrode of claim 1, wherein said membrane is substantially fluorous.

8. The electrode of claim 1, wherein said membrane is substantially non-selective to ions.

9. The non-selective membrane of claim 8, wherein said membrane contains an ionic liquid.

10. The electrode of claim 1, wherein solid contact member is a coating.

11. A ion selective electrode system comprising:
a. at least one working electrode having a electronically conducting member, a solid contact member, and a ion selective membrane, and
b. at least one reference electrode having a electronically conducting member, a solid contact member, and a non-selective ion conducting membrane, and
c. and a voltmeter
d. said working electrode and reference electrode being in electronic communication with said voltmeter whereby the potential between said working and said reference electrode may be measured, and
e. said conductor body providing a predetermined contiguous electronically conductive porous network whereby said solid contact coating and membrane adheres to said conductor body.

12. A ion selective electrode system of claim 10 wherein said voltmeter comprises an input impedance of greater than 1 tera ohm.

13. A ion selective electrode system of claim 10 wherein said solid contact coating includes a metal redox pair or a semiconducting polymer.

14. An ion selective electrode system of claim 10, wherein said membrane disposed on said reference electrode contains an ionic liquid.

15. A electrode comprising:
a. a fluidic fitting member, and
b. a electrode having a electronically conducting member, a solid contact member, and a ion selective membrane or a reference electrode membrane, disposed therein, and
c. a resilient polymeric member that sealingly engages and electrically insulates said electrode disposed within said fluidic fitting, and
d. a fluid sealing member whereby the fluid is prevented from leaking under hydrostatic pressure, and
e. said fluidic fitting member being sealingly engaged with said electronically conducting member and said fluid sealing member being sealingly engaged with said resilient polymeric member.

16. A fluid fitting as in claim 14 wherein fitting can include threaded or non threaded members.

17. A resilient polymeric member as in claim 14 wherein said member is a heat shrink tubing.

18. A fluid sealing member as in claim 14 wherein fluid sealing member may include ferrules, o-rings, or chisel points whereby a fluidic seal may be effective.

19. A fluid fitting member as in claim 14, wherein fitting member releasably engages an electrical connection.

20. A coaxial cable comprising:
a. a central conductor wire, and
b. a insulators, and
d. a shielding layer, and
e. said central conductor being coated with one or more insulators and shielding layers wherein said shielding layers are composites of radiation absorbing nanomaterials dispersed in a conducting polymer matrix.
